(19) United States
(12) Patent Application Publication
(10) Pub. No.: US 2026/0099202 A1
(43) Pub. Date: Apr. 9, 2026

(54) ELECTRONIC DEVICE AND METHOD FOR ADJUSTING ORDER OF DATA SETS FOR CONTROLLING LED, AND COMPUTER-READABLE STORAGE MEDIUM

(71) Applicant: Samsung Electronics Co., Ltd., Suwon-si (KR)

(72) Inventors: Bonkon KOO, Suwon-si (KR); Donghyun YEOM, Suwon-si (KR); Sungkweon PARK, Suwon-si (KR); Jisu RYU, Suwon-si (KR); Sungoh KIM, Suwon-si (KR); Jinmo KANG, Suwon-si (KR)

(21) Appl. No.: 19/416,488

(22) Filed: Dec. 11, 2025

Related U.S. Application Data
(63) Continuation of application No. PCT/KR2024/006096, filed on May 7, 2024.

(30) Foreign Application Priority Data
Jul. 6, 2023 (KR) 10-2023-0088003
Aug. 4, 2023 (KR) 10-2023-0102495

(51) Int. Cl. G06F 3/01; G02B 27/01; G06V 10/141; G06V 40/18

(52) U.S. Cl. CPC G06F 3/013; G02B 27/017; G06V 10/141; G06V 40/197; G02B 2027/0138

(57) ABSTRACT

A wearable device is provided. The wearable device includes a plurality of light emitting diodes (LEDs), a dynamic vision sensor (DVS) camera, memory, comprising one or more storage media, storing one or more computer programs, one or more processors communicatively coupled to the plurality of LEDs, the DVS camera, and the memory, wherein the one or more computer programs include computer-executable instructions that, when executed by the one or more processors individually or collectively, cause the wearable device to: obtain, from the DVS camera, first image data based on first light emitted from the plurality of LEDs using a first control data set among a plurality of control data sets for controlling the plurality of LEDs, obtain, from the DVS camera, second image data based on second light emitted from the plurality of LEDs using a second control data set among the plurality of control data sets, using first brightness data corresponding to the first light and second brightness data corresponding to the second light, convert the first image data and the second image data into an image, and based on identifying an eye of a user wearing the wearable device using the image, execute a function related to the eye.

### CROSS-REFERENCE TO RELATED APPLICATION(S)

This application is a continuation application, claiming priority under 35 U.S.C. § 365 (c), of an International application No. PCT/KR2024/006096, filed on May 7, 2024, which is based on and claims the benefit of a Korean patent application number 10-2023-0088003, filed on Jul. 6, 2023, in the Korean Intellectual Property Office, and of a Korean patent application number 10-2023-0102495, filed on Aug. 4, 2023, in the Korean Intellectual Property Office, the disclosure of each of which is incorporated by reference herein in its entirety.

### BACKGROUND

### 1. Field

The disclosure relates to an electronic device, a method, and a computer-readable storage medium for adjusting an order of data sets for controlling a light emitting diode (LED).

### 2. Description of Related Art

In order to provide an enhanced user experience, an electronic device is being developed that provides an augmented reality (AR) service which displays computer-generated information in connection with an external object in the real-world. The electronic device may be a wearable device that may be worn by a user. For example, the electronic device may be AR glasses and/or a head-mounted device (HMD). The electronic device may perform a function for recognizing an iris of the user.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a computer-readable storage medium for adjusting an order of data sets for controlling a light emitting diode (LED).

Additional aspects will be set forth in part in the description which follows and, in part, will be apparent from the description, or may be learned by practice of the presented embodiments.

In accordance with an aspect of the disclosure, a wearable device is provided. The wearable device includes a plurality of light emitting diodes (LEDs), a dynamic vision sensor (DVS) camera, memory, comprising one or more storage media, storing one or more computer programs, and one or more processors communicatively coupled to the plurality of LEDs, the DVS camera, and the memory, wherein the one or more computer programs include computer-executable instructions that, when executed by the one or more processors individually or collectively, cause the wearable device to obtain, from the DVS camera, first image data based on first light emitted from the plurality of LEDs using a first control data set among a plurality of control data sets for controlling the plurality of LEDs, obtain, from the DVS camera, second image data based on second light emitted from the plurality of LEDs using a second control data set among the plurality of control data sets, using first brightness data corresponding to the first light and second brightness data corresponding to the second light, convert the first image data and the second image data into an image, and based on identifying an eye of a user wearing the wearable device using the image, execute a function related to the eye.

In accordance with another aspect of the disclosure, a method performed by a wearable device is provided. The method includes obtaining, by the wearable device, from a dynamic vision sensor (DVS) camera, first image data based on first light emitted from a plurality of light emitting diodes (LEDs) using a first control data set among a plurality of control data sets for controlling the plurality of LEDs, obtaining, by the wearable device, from the DVS camera, second image data based on second light emitted from the plurality of LEDs using a second control data set among the plurality of control data sets, using first brightness data corresponding to the first light and second brightness data corresponding to the second light, converting, by the wearable device, the first image data and the second image data into an image, and based on identifying an eye of a user wearing the wearable device using the image, executing, by the wearable device, a function related to the eye.

In accordance with another aspect of the disclosure, one or more non-transitory computer-readable storage media storing one or more computer programs including computer-executable instructions that, when executed by one or more processors of a wearable device individually or collectively, cause the wearable device to perform operations are provided. The operations include obtaining, from a DVS camera, first image data based on first light emitted from a plurality of LEDs using a first control data set among a plurality of control data sets for controlling the plurality of LEDs. The operations include obtaining, by the wearable device, from the DVS camera, second image data based on second light emitted from the plurality of LEDs using a second control data set among the plurality of control data sets, using first brightness data corresponding to the first light and second brightness data corresponding to the second light, converting, by the wearable device, the first image data and the second image data into an image, and based on identifying an eye of a user wearing the wearable device using the image, executing, by the wearable device, a function related to the eye.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a block diagram of a wearable device according to an embodiment of the disclosure;

FIG. 2A illustrates an example of a perspective view of a wearable device according to an embodiment of the disclosure;

FIG. 2B illustrates an example of one or more hardware disposed in a wearable device according to an embodiment of the disclosure;

FIGS. 3A and 3B illustrate an example of an exterior of a wearable device according to various embodiments of the disclosure;

FIG. 4 illustrates an example of an operation for a wearable device to obtain a plurality of control data sets according to an embodiment of the disclosure;

FIG. 5 illustrates an example of a flowchart indicating an operation of a wearable device according to an embodiment of the disclosure;

FIG. 6 illustrates an example of an operation in which a wearable device obtains image data according to an embodiment of the disclosure;

FIG. 7 illustrates an example of image data in which a wearable device is mapped to a plurality of control data sets according to an embodiment of the disclosure;

FIG. 8 illustrates an example of a flowchart indicating an operation of a wearable device according to an embodiment of the disclosure; and

FIG. 9 is a block diagram of an electronic device in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

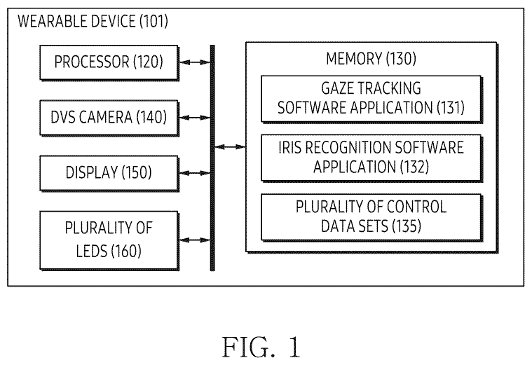

FIG. 1 illustrates an example of a block diagram of a wearable device according to an embodiment of the disclosure. In an embodiment, in terms of being owned by a user, a wearable device 101 may be referred to as a terminal (or a user terminal). The terminal may include, for example, a personal computer (PC) such as a laptop and a desktop. The terminal may include, for example, a smartphone, a smartpad, and/or a tablet PC. The terminal may include a smart accessory such as a smartwatch and/or a head-mounted device (HMD). The wearable device 101 of FIG. 1 may include a head-mounted display (HMD) wearable on a head of the user. In order to provide a user interface (UI) based on virtual reality (VR), augmented reality (AR), and/or mixed reality (MR) to a user wearing the wearable device 101, the wearable device 101 may control a camera and/or a sensor.

Referring to FIG. 1, according to an embodiment, the wearable device 101 may include at least one of a processor 120, memory 130, a dynamic vision sensor (DVS) camera 140, a display 150, or a plurality of light emitting diodes (LEDs) 160. The processor 120, the memory 130, the DVS camera 140, the display 150, and the plurality of LEDs 160 may be electrically and/or operatively connected to each other by an electronic component (or an electrical component), such as a communication bus.

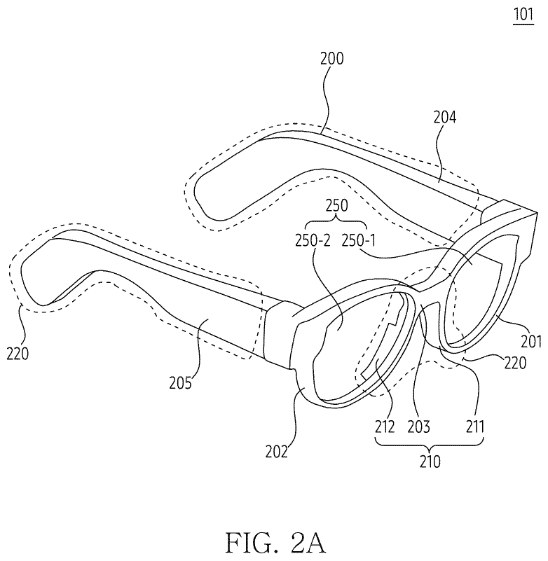

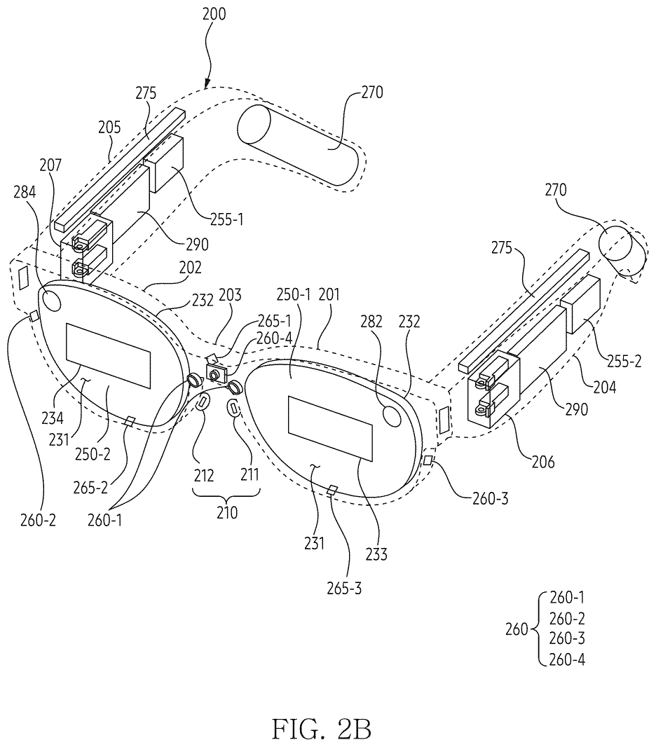

In an embodiment, hardware of the wearable device 101 being operatively coupled may mean that a direct connection or an indirect connection between the hardware is established wired or wirelessly, such that second hardware is controlled by first hardware among the hardware. Although illustrated based on different blocks, an embodiment is not limited thereto, and a portion of hardware of FIG. 2A or 2B (e.g., at least a portion of the processor 120, the memory 130 and communication circuitry (not illustrated)) may be included in a single integrated circuit, such as a system on a chip (SoC). A type and/or the number of hardware included in the wearable device 101 is not limited to those illustrated in FIG. 1. For example, the wearable device 101 may include only a portion of hardware components illustrated in FIG. 1.

According to an embodiment, the processor 120 of the wearable device 101 may include hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). The number of processors 120 may be one or more. For example, the processor 120 may have a multi-core processor structure such as a dual core, a quad core or a hexa core.

According to an embodiment, the memory 130 of the wearable device 101 may include a hardware component for storing data and/or instructions inputted to and/or outputted from the processor 120. The memory 130 may include, for example, volatile memory such as random-access memory (RAM) and/or non-volatile memory such as read-only memory (ROM). The volatile memory may include, for example, at least one of dynamic RAM (DRAM), static RAM (SRAM), cache RAM, or pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), or an embedded multimedia card (eMMC).

According to an embodiment, the wearable device 101 may identify a change in an object using the dynamic vision sensor (DVS) camera 140. For example, the DVS camera 140 may include a motion sensor (or a motion recognition sensor) for recognizing movement of an object. For example, the wearable device 101 may identify a difference between frame images using the DVS camera 140 of the wearable device 101. The wearable device 101 may obtain information indicating pixels having no difference and pixels having a difference by comparing a first frame image and a second frame image obtained using the DVS camera 140. For example, the difference between the frame images may include a change in a position of an object in the frame images. The difference between the frame images may include a change in at least one pixel included in each of the frame images. The change in at least one pixel may include a change in brightness data and/or color data on a pixel. The DVS camera 140 may be disposed toward an eye of the user wearing the wearable device 101 in order to identify the eye. When the user moves the eye, the wearable device 101 may identify movement of the eye of the user using the DVS camera 140.

According to an embodiment, the display 150 of the wearable device 101 may output visualized information to the user. For example, the display 150 may be controlled by a controller such as a graphic processing unit (GPU) to output visualized information to the user. The display 150 may include a liquid crystal display (LCD), a plasma display panel (PDP), and/or one or more light emitting diodes (LEDs). The LED may include an organic LED (OLED). The display 150 may include electronic paper. The display 150 may have a form that is at least partially curved and/or may have a form that is deformable.

The plurality of LEDs 160 of the wearable device 101 according to an embodiment may output light in a designated wavelength band (e.g., an infrared ray). Each of the plurality of LEDs 160 may be disposed in a portion of the wearable device 101 to emit light toward the eye of the user wearing the wearable device 101. According to an embodiment, the wearable device 101 may change a position at which the plurality of LEDs 160 are disposed. However, it is not limited thereto. In terms of outputting an infrared ray, the plurality of LEDs 160 may be referred to as infrared light emitting diodes (IR LEDs).

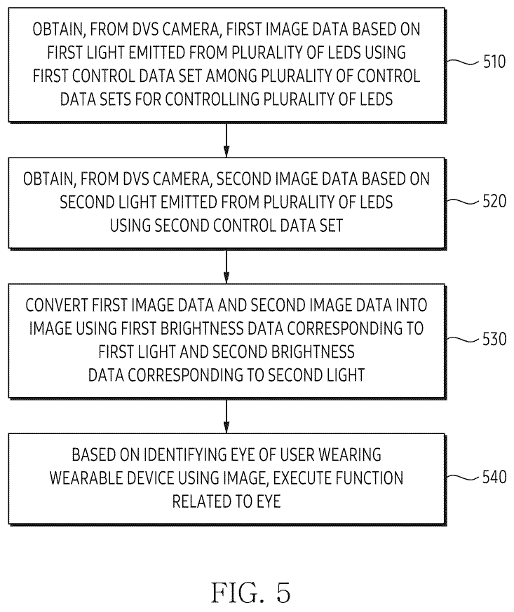

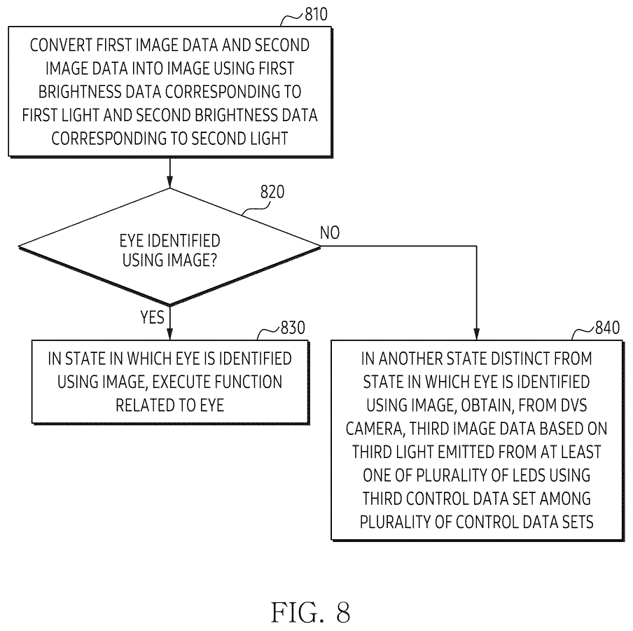

According to an embodiment, one or more instructions (or commands) indicating a computation and/or an operation to be performed on data by the processor 120 of the wearable device 101 may be stored in the memory 130 of the wearable device 101. A set of one or more instructions may be referred to as firmware, an operating system, a process, a routine, a sub-routine and/or an application. For example, when a set of a plurality of instructions distributed in a form of an operating system, firmware, a driver, and/or an application is executed, the wearable device 101 and/or the processor 120 may perform at least one of operations of FIG. 5 or 8. Hereinafter, an application being installed in the wearable device 101 may mean that one or more applications provided in a form of an application are stored in the memory 130, and that the one or more applications are stored in a format (e.g., a file having an extension designated by an operating system of the wearable device 101) executable by the processor 120. As an example, the application may include a program and/or a library related to a service provided to the user.

For example, the wearable device 101 may track the eye of the user identified using the DVS camera 140 based on execution of a gaze tracking software application 131. The wearable device 101 may identify a gaze corresponding to the eye based on the execution of the gaze tracking software application 131. The wearable device 101 may initiate execution of at least one function to perform an interaction with an external object (or a virtual object) matching the gaze. However, it is not limited thereto.

For example, the wearable device 101 may identify the user by identifying the eye of the user using the DVS camera 140 based on execution of an iris recognition software application 132. The wearable device 101 may identify the user based on identifying a shape of the eye (or an iris pattern). The wearable device 101 may initiate execution of the iris recognition software application 132 to authenticate the user based on execution of a function accessible by the user. After authenticating the user with the eye identified using the DVS camera 140 based on execution of the iris recognition software application 132, the wearable device 101 may initiate execution of the function accessible by the user.

The wearable device 101 according to an embodiment may identify a plurality of control data sets 135 for outputting light toward the eye using the plurality of LEDs 160 in order to obtain an image indicating the eye of the user using the DVS camera 140. The plurality of control data sets 135 may include brightness information set to be suitable for identifying the eye of the user. In terms of being related to the user, the plurality of control data sets 135 may be referred to as control profile information (or a control profile data set). In terms of being related to the eye, the plurality of control data sets 135 may be referred to as iris sensing information.

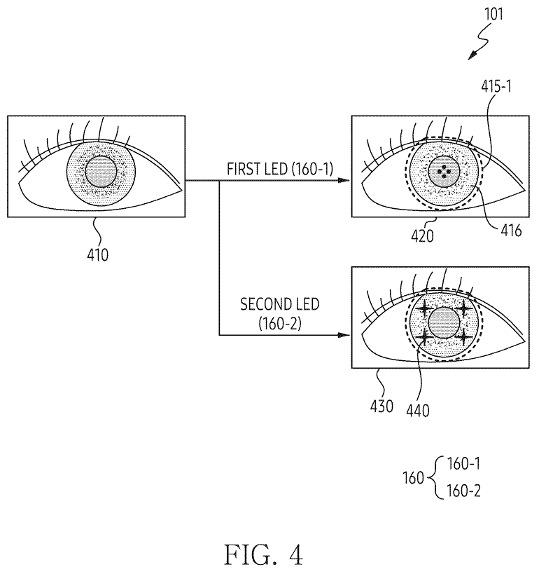

For example, the plurality of control data sets 135 may be obtained using a user interface for identifying the eye of the user. The plurality of control data sets 135 may include information indicating intensity of light emitted by each of the plurality of LEDs to identify the eye of the user wearing the wearable device 101. An operation in which the wearable device 101 obtains the plurality of control data sets 135 will be described later with reference to FIG. 4.

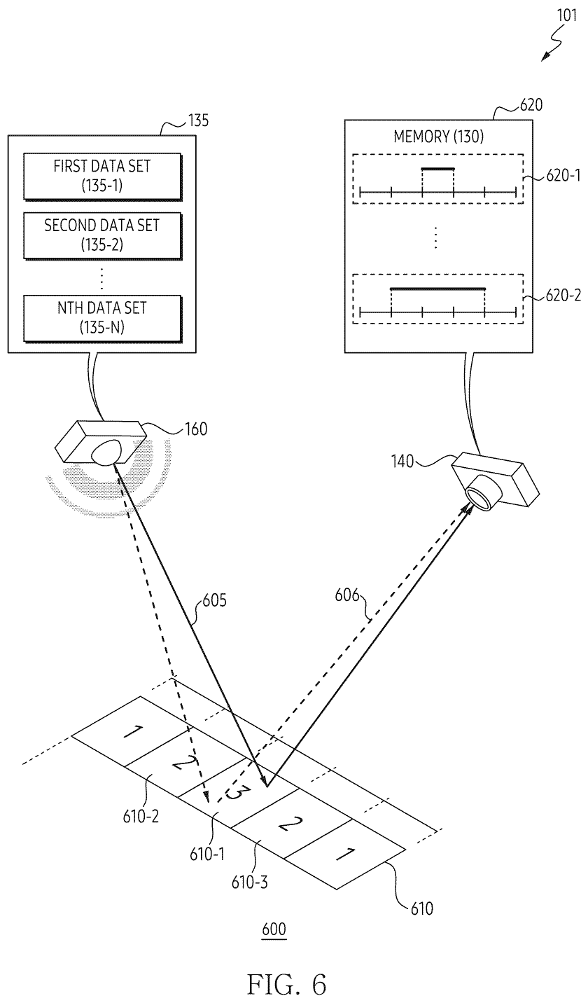

As described above, the wearable device 101 according to an embodiment may cause a change in the eye based on controlling the plurality of LEDs 160 to emit light toward the eye of the user. The wearable device 101 may identify the change in the eye using the DVS camera 140. The wearable device 101 may obtain image data (e.g., image data 620 of FIG. 6) indicating the eye based on identifying the change in the eye. The wearable device 101 may convert the image data into an image for identifying the eye, using brightness data (e.g., brightness data 630 of FIG. 6) corresponding to the image data. Based on identifying the eye using the DVS camera 140, the wearable device 101 may obtain information on the eye of the user based on relatively low power consumption compared to using another camera (not illustrated) distinct from the DVS camera 140. Based on identifying the eye using the DVS camera 140, the wearable device 101 may obtain information on the eye of the user based on relatively fast speed.

FIG. 2A illustrates an example of a perspective view of a wearable device according to an embodiment of the disclosure. A wearable device 101 according to an embodiment may have a form of glasses wearable on a body part (e.g., a head) of a user. The wearable device 101 of FIGS. 2A and 2B may be an example of the wearable device 101 of FIG. 1. The wearable device 101 may include a head-mounted display (HMD). For example, a housing of the wearable device 101 may include a flexible material such as rubber and/or silicon having a form closely attached to a portion of a head of the user (e.g., a portion of a face surrounding two eyes). For example, a housing of the wearable device 101 may include one or more straps able to be twined around the head of the user and/or one or more temples attachable to ears of the head.

Referring to FIG. 2A, the wearable device 101 according to an embodiment may include at least one display 250 and a frame 200 supporting the at least one display 250.

According to an embodiment, the wearable device 101 may be wearable on a portion of the user's body. The wearable device 101 may provide augmented reality (AR), virtual reality (VR), or mixed reality (MR) combining the augmented reality and the virtual reality to a user wearing the wearable device 101. For example, the wearable device 101 may display a virtual reality image provided from at least one optical device 282 and 284 of FIG. 2B on at least one display 250, in response to a user's preset gesture obtained through a motion recognition camera 260-2 and 260-3 of FIG. 2B.

According to an embodiment, the at least one display 250 may provide visual information to a user. For example, the at least one display 250 may include a transparent or translucent lens. The at least one display 250 may include a first display 250-1 and/or a second display 250-2 spaced apart from the first display 250-1. For example, the first display 250-1 and the second display 250-2 may be disposed at positions corresponding to the user's left and right eyes, respectively.

Referring to FIG. 2B, the at least one display 250 may provide visual information transmitted through a lens included in the at least one display 250 from ambient light to a user and other visual information distinguished from the visual information2. The lens may be formed based on at least one of a fresnel lens, a pancake lens, or a multi-channel lens. For example, the at least one display 250 may include a first surface 231 and a second surface 232 opposite to the first surface 231. A display area may be formed on the second surface 232 of at least one display 250. When the user wears the wearable device 101, ambient light may be transmitted to the user by being incident on the first surface 231 and being penetrated through the second surface 232. For another example, the at least one display 250 may display an augmented reality image in which a virtual reality image provided by the at least one optical device 282 and 284 is combined with a reality screen transmitted through ambient light, on a display area formed on the second surface 232.

According to an embodiment, the at least one display 250 may include at least one waveguide 233 and 234 that transmits light transmitted from the at least one optical device 282 and 284 by diffracting to the user. The at least one waveguide 233 and 234 may be formed based on at least one of glass, plastic, or polymer. A nano pattern may be formed on at least a portion of the outside or inside of the at least one waveguide 233 and 234. The nano pattern may be formed based on a grating structure having a polygonal or curved shape. Light incident to an end of the at least one waveguide 233 and 234 may be propagated to another end of the at least one waveguide 233 and 234 by the nano pattern. The at least one waveguide 233 and 234 may include at least one of at least one diffraction element (e.g., a diffractive optical element (DOE), a holographic optical element (HOE)), and a reflection element (e.g., a reflection mirror). For example, the at least one waveguide 233 and 234 may be disposed in the wearable device 101 to guide a screen displayed by the at least one display 250 to the user's eyes. For example, the screen may be transmitted to the user's eyes based on total internal reflection (TIR) generated in the at least one waveguide 233 and 234.

The wearable device 101 may analyze an object included in a real image collected through a photographing camera 260-4, combine with a virtual object corresponding to an object that becomes a subject of augmented reality provision among the analyzed object, and display on the at least one display 250. The virtual object may include at least one of text and images for various information associated with the object included in the real image. The wearable device 101 may analyze the object based on a multi-camera such as a stereo camera. For the object analysis, the wearable device 101 may execute space recognition (e.g., simultaneous localization and mapping (SLAM)) using the multi-camera and/or time-of-flight (ToF). The user wearing the wearable device 101 may watch an image displayed on the at least one display 250.

According to an embodiment, a frame 200 may be configured with a physical structure in which the wearable device 101 may be worn on the user's body. According to an embodiment, the frame 200 may be configured so that when the user wears the wearable device 101, the first display 250-1 and the second display 250-2 may be positioned corresponding to the user's left and right eyes. The frame 200 may support the at least one display 250. For example, the frame 200 may support the first display 250-1 and the second display 250-2 to be positioned at positions corresponding to the user's left and right eyes.

Referring to FIG. 2A, according to an embodiment, the frame 200 may include an area 220 at least partially in contact with the portion of the user's body in case that the user wears the wearable device 101. For example, the area 220 of the frame 200 in contact with the portion of the user's body may include an area in contact with a portion of the user's nose, a portion of the user's ear, and a portion of the side of the user's face that the wearable device 101 contacts. According to an embodiment, the frame 200 may include a nose pad 210 that is contacted on the portion of the user's body. When the wearable device 101 is worn by the user, the nose pad 210 may be contacted on the portion of the user's nose. The frame 200 may include a first temple 204 and a second temple 205, which are contacted on another portion of the user's body that is distinct from the portion of the user's body.

For example, the frame 200 may include a first rim 201 surrounding at least a portion of the first display 250-1, a second rim 202 surrounding at least a portion of the second display 250-2, a bridge 203 disposed between the first rim 201 and the second rim 202, a first pad 211 disposed along a portion of the edge of the first rim 201 from one end of the bridge 203, a second pad 212 disposed along a portion of the edge of the second rim 202 from the other end of the bridge 203, the first temple 204 extending from the first rim 201 and fixed to a portion of the wearer's ear, and the second temple 205 extending from the second rim 202 and fixed to a portion of the ear opposite to the ear. The first pad 211 and the second pad 212 may be in contact with the portion of the user's nose, and the first temple 204 and the second temple 205 may be in contact with a portion of the user's face and the portion of the user's ear. The temples 204 and 205 may be rotatably connected to the rim through hinge units 206 and 207 of FIG. 2B. The first temple 204 may be rotatably connected with respect to the first rim 201 through the first hinge unit 206 disposed between the first rim 201 and the first temple 204. The second temple 205 may be rotatably connected with respect to the second rim 202 through the second hinge unit 207 disposed between the second rim 202 and the second temple 205. According to an embodiment, the wearable device 101 may identify an external object (e.g., a user's fingertip) touching the frame 200 and/or a gesture performed by the external object by using a touch sensor, a grip sensor, and/or a proximity sensor formed on at least a portion of the surface of the frame 200.

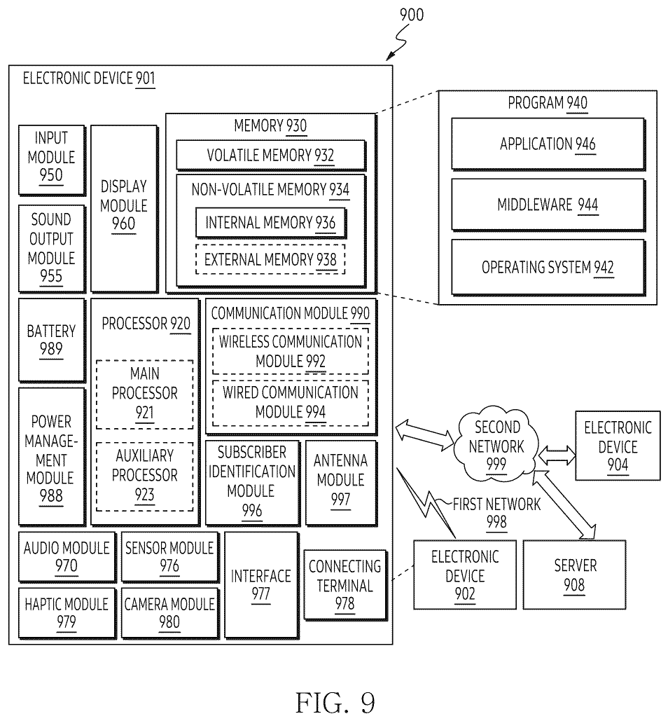

According to an embodiment, the wearable device 101 may include hardware (e.g., hardware to be described later based on the block diagram of FIG. 9) that performs various functions. For example, the hardware may include a battery module 270, an antenna module 275, the at least one optical device 282 and 284, speakers (e.g., speakers 255-1 and 255-2), a microphone (e.g., microphones 265-1, 265-2, and 265-3), a light emitting module (not illustrated), and/or a printed circuit board (PCB) 290 (e.g., printed circuit board). Various hardware may be disposed in the frame 200.

According to an embodiment, the microphone (e.g., the microphones 265-1, 265-2, and 265-3) of the wearable device 101 may obtain a sound signal, by being disposed on at least a portion of the frame 200. The first microphone 265-1 disposed on the bridge 203, the second microphone 265-2 disposed on the second rim 202, and the third microphone 265-3 disposed on the first rim 201 are illustrated in FIG. 2B, but the number and disposition of the microphone 265 are not limited to an embodiment of FIG. 2B. In case that the number of the microphone 265 included in the wearable device 101 is two or more, the wearable device 101 may identify a direction of the sound signal by using a plurality of microphones disposed on different portions of the frame 200.

According to an embodiment, the at least one optical device 282 and 284 may project a virtual object on the at least one display 250 in order to provide various image information to the user. For example, the at least one optical device 282 and 284 may be a projector. The at least one optical device 282 and 284 may be disposed adjacent to the at least one display 250 or may be included in the at least one display 250 as a portion of the at least one display 250. According to an embodiment, the wearable device 101 may include a first optical device 282 corresponding to the first display 250-1, and a second optical device 284 corresponding to the second display 250-2. For example, the at least one optical device 282 and 284 may include the first optical device 282 disposed at a periphery of the first display 250-1 and the second optical device 284 disposed at a periphery of the second display 250-2. The first optical device 282 may transmit light to the first waveguide 233 disposed on the first display 250-1, and the second optical device 284 may transmit light to the second waveguide 234 disposed on the second display 250-2.

In an embodiment, a camera 260 may include the photographing camera 260-4, an eye tracking camera (ET CAM) 260-1, and/or the motion recognition camera 260-2 and 260-3. The photographing camera 260-4, the eye tracking camera 260-1, and the motion recognition camera 260-2 and 260-3 may be disposed at different positions on the frame 200 and may perform different functions. The eye tracking camera 260-1 may output data indicating a position of eye or a gaze of the user wearing the wearable device 101. For example, the wearable device 101 may detect the gaze from an image including the user's pupil obtained through the eye tracking camera 260-1. The wearable device 101 may identify an object (e.g., a real object, and/or a virtual object) focused by the user, by using the user's gaze obtained through the eye tracking camera 260-1. The wearable device 101 identifying the focused object may execute a function (e.g., gaze interaction) for interaction between the user and the focused object. The wearable device 101 may represent a portion corresponding to eye of an avatar indicating the user in the virtual space, by using the user's gaze obtained through the eye tracking camera 260-1. The wearable device 101 may render an image (or a screen) displayed on the at least one display 250, based on the position of the user's eye. For example, visual quality (e.g., resolution, brightness, saturation, grayscale, and PPI) of a first area related to the gaze within the image and visual quality of a second area distinguished from the first area may be different. The wearable device 101 may obtain an image having the visual quality of the first area matching the user's gaze and the visual quality of the second area by using foveated rendering. For example, when the wearable device 101 supports an iris recognition function, user authentication may be performed based on iris information obtained using the eye tracking camera 260-1. An example in which the eye tracking camera 260-1 is disposed toward the user's right eye is illustrated in FIG. 2B, but the embodiment is not limited thereto, and the eye tracking camera 260-1 may be disposed alone toward the user's left eye or may be disposed toward two eyes.

In an embodiment, the photographing camera 260-4 may photograph a real image or background to be matched with a virtual image in order to implement the augmented reality or mixed reality content. The photographing camera 260-4 may be used to obtain an image having a high resolution based on a high resolution (HR) or a photo video (PV). The photographing camera 260-4 may photograph an image of a specific object existing at a position viewed by the user and may provide the image to the at least one display 250. The at least one display 250 may display one image in which a virtual image provided through the at least one optical device 282 and 284 is overlapped with information on the real image or background including an image of the specific object obtained by using the photographing camera 260-4. The wearable device 101 may compensate for depth information (e.g., a distance between the wearable device 101 and an external object obtained through a depth sensor), by using an image obtained through the photographing camera 260-4. The wearable device 101 may perform object recognition through an image obtained using the photographing camera 260-4. The wearable device 101 may perform a function (e.g., auto focus) of focusing an object (or subject) within an image and/or an optical image stabilization (OIS) function (e.g., an anti-shaking function) by using the photographing camera 260-4. While displaying a screen representing a virtual space on the at least one display 250, the wearable device 101 may perform a pass through function for displaying an image obtained through the photographing camera 260-4 overlapping at least a portion of the screen. In an embodiment, the photographing camera 260-4 may be disposed on the bridge 203 disposed between the first rim 201 and the second rim 202.

The eye tracking camera 260-1 may implement a more realistic augmented reality by matching the user's gaze with the visual information provided on the at least one display 250, by tracking the gaze of the user wearing the wearable device 101. For example, when the user looks at the front, the wearable device 101 may naturally display environment information associated with the user's front on the at least one display 250 at a position where the user is positioned. The eye tracking camera 260-1 may be configured to capture an image of the user's pupil in order to determine the user's gaze. For example, the eye tracking camera 260-1 may receive gaze detection light reflected from the user's pupil and may track the user's gaze based on the position and movement of the received gaze detection light. In an embodiment, the eye tracking camera 260-1 may be disposed at a position corresponding to the user's left and right eyes. For example, the eye tracking camera 260-1 may be disposed in the first rim 201 and/or the second rim 202 to face the direction in which the user wearing the wearable device 101 is positioned.

The motion recognition camera 260-2 and 260-3 may provide a specific event to the screen provided on the at least one display 250 by recognizing the movement of the whole or portion of the user's body, such as the user's torso, hand, or face. The motion recognition camera 260-2 and 260-3 may obtain a signal corresponding to motion by recognizing the user's motion (e.g., gesture recognition), and may provide a display corresponding to the signal to the at least one display 250. The processor may identify a signal corresponding to the operation and may perform a preset function based on the identification. The motion recognition camera 260-2 and 260-3 may be used to perform simultaneous localization and mapping (SLAM) for 6 degrees of freedom pose (6 dof pose) and/or a space recognition function using a depth map. The processor may perform a gesture recognition function and/or an object tracking function, by using the motion recognition camera 260-2 and 260-3. In an embodiment, the motion recognition camera 260-2 and camera 260-3 may be disposed on the first rim 201 and/or the second rim 202.

The camera 260 included in the wearable device 101 is not limited to the above-described eye tracking camera 260-1 and the motion recognition camera 260-2 and 260-3. For example, the wearable device 101 may identify an external object included in the FoV by using a camera disposed toward the user's FoV. Identifying of the external object by the wearable device 101 may be performed based on a sensor for identifying a distance between the wearable device 101 and the external object, such as a depth sensor and/or a time of flight (ToF) sensor. The camera 260 disposed toward the FoV may support an autofocus function and/or an optical image stabilization (OIS) function. For example, in order to obtain an image including a face of the user wearing the wearable device 101, the wearable device 101 may include the camera 260 (e.g., a face tracking (FT) camera) disposed toward the face.

Although not illustrated, the wearable device 101 according to an embodiment may further include a light source (e.g., LED) that emits light toward a subject (e.g., user's eyes, face, and/or an external object in the FoV) photographed by using the camera 260. The light source may include an LED having an infrared wavelength. The light source may be disposed on at least one of the frame 200, and the hinge units 206 and 207.

According to an embodiment, the battery module 270 may supply power to electronic components of the wearable device 101. In an embodiment, the battery module 270 may be disposed in the first temple 204 and/or the second temple 205. For example, the battery module 270 may be a plurality of battery modules 270. The plurality of battery modules 270, respectively, may be disposed on each of the first temple 204 and the second temple 205. In an embodiment, the battery module 270 may be disposed at an end of the first temple 204 and/or the second temple 205.

The antenna module 275 may transmit the signal or power to the outside of the wearable device 101 or may receive the signal or power from the outside. In an embodiment, the antenna module 275 may be disposed in the first temple 204 and/or the second temple 205. For example, the antenna module 275 may be disposed close to one surface of the first temple 204 and/or the second temple 205.

The speaker 255 may output a sound signal to the outside of the wearable device 101. A sound output module may be referred to as a speaker. In an embodiment, the speaker 255 may be disposed in the first temple 204 and/or the second temple 205 in order to be disposed adjacent to the ear of the user wearing the wearable device 101. For example, the speaker 255 may include a second speaker 255-2 disposed adjacent to the user's left ear by being disposed in the first temple 204, and a first speaker 255-1 disposed adjacent to the user's right ear by being disposed in the second temple 205.

The light emitting module (not illustrated) may include at least one light emitting element. The light emitting module may emit light of a color corresponding to a specific state or may emit light through an operation corresponding to the specific state in order to visually provide information on a specific state of the wearable device 101 to the user. For example, when the wearable device 101 requires charging, it may emit red light at a constant cycle. In an embodiment, the light emitting module may be disposed on the first rim 201 and/or the second rim 202.

Referring to FIG. 2B, according to an embodiment, the wearable device 101 may include the printed circuit board (PCB) 290. The PCB 290 may be included in at least one of the first temple 204 or the second temple 205. The PCB 290 may include an interposer disposed between at least two sub PCBs. On the PCB 290, one or more hardware (e.g., hardware illustrated by different blocks of FIG. 4) included in the wearable device 101 may be disposed. The wearable device 101 may include a flexible PCB (FPCB) for interconnecting the hardware.

According to an embodiment, the wearable device 101 may include at least one of a gyro sensor, a gravity sensor, and/or an acceleration sensor for detecting the posture of the wearable device 101 and/or the posture of a body part (e.g., a head) of the user wearing the wearable device 101. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 101 may identify the user's motion and/or gesture performed to execute or stop a specific function of the wearable device 101 based on the IMU.

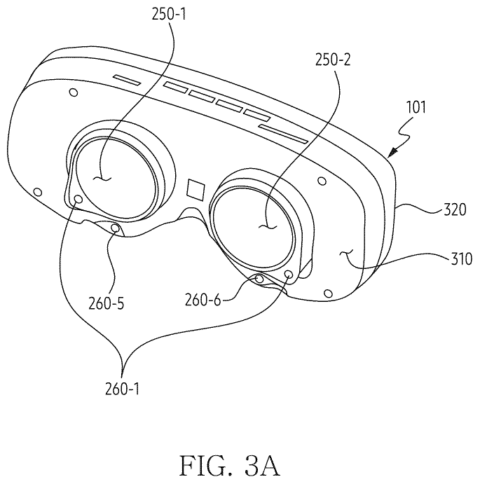

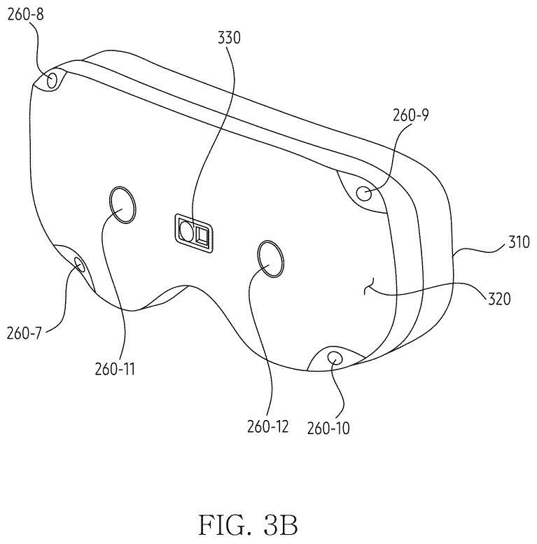

FIGS. 3A and 3B illustrate an example of an exterior of a wearable device according to various embodiments of the disclosure. The wearable device 101 of FIGS. 3A and 3B may be an example of the wearable device 101 of FIG. 1. According to an embodiment, an example of an exterior of a first surface 310 of a housing of the wearable device 101 may be illustrated in FIG. 3A, and an example of an exterior of a second surface 320 opposite to the first surface 310 may be illustrated in FIG. 3B.

Referring to FIG. 3A, according to an embodiment, the first surface 310 of the wearable device 101 may have an attachable shape on the user's body part (e.g., the user's face). Although not illustrated, the wearable device 101 may further include a strap for being fixed on the user's body part, and/or one or more temples (e.g., the first temple 204 and/or the second temple 205 of FIGS. 2A and 2B). A first display 250-1 for outputting an image to the left eye among the user's two eyes and a second display 250-2 for outputting an image to the right eye among the user's two eyes may be disposed on the first surface 310. The wearable device 101 may further include rubber or silicon packing, which are formed on the first surface 310, for preventing interference by light (e.g., ambient light) different from the light emitted from the first display 250-1 and the second display 250-23.

According to an embodiment, the wearable device 101 may include cameras 260-1 for photographing and/or tracking two eyes of the user adjacent to each of the first display 250-1 and the second display 250-2. The cameras 260-1 may be referred to as the gaze tracking camera 260-1 of FIG. 2B. According to an embodiment, the wearable device 101 may include cameras 260-5 and 260-6 for photographing and/or recognizing the user's face. The cameras 260-5 and 260-6 may be referred to as a FT camera. The wearable device 101 may control an avatar representing a user in a virtual space, based on a motion of the user's face identified using the cameras 260-5 and 260-6. For example, the wearable device 101 may change a texture and/or a shape of a portion (e.g., a portion of an avatar representing a human face) of the avatar, by using information obtained by the cameras 260-5 and 260-6 (e.g., the FT camera) and representing the facial expression of the user wearing the wearable device 101.

Referring to FIG. 3B, a camera (e.g., cameras 260-7, 260-8, 260-9, 260-10, 260-11, and 260-12), and/or a sensor (e.g., the depth sensor 330) for obtaining information associated with the external environment of the wearable device 101 may be disposed on the second surface 320 opposite to the first surface 310 of FIG. 3A. For example, the cameras 260-7, 260-8, 260-9, and 260-10 may be disposed on the second surface 320 in order to recognize an external object. The cameras 260-7, 260-8, 260-9, and 260-10 may be referred to as the motion recognition cameras 260-2 and 260-3 of FIG. 2B.

For example, by using cameras 260-11 and 260-12, the wearable device 101 may obtain an image and/or video to be transmitted to each of the user's two eyes. The camera 260-11 may be disposed on the second surface 320 of the wearable device 101 to obtain an image to be displayed through the second display 250-2 corresponding to the right eye among the two eyes. The camera 260-12 may be disposed on the second surface 320 of the wearable device 101 to obtain an image to be displayed through the first display 250-1 corresponding to the left eye among the two eyes. The cameras 260-11 and 260-12 may be referred to as the photographing camera 260-4 of FIG. 2B.

According to an embodiment, the wearable device 101 may include the depth sensor 330 disposed on the second surface 320 in order to identify a distance between the wearable device 101 and the external object. By using the depth sensor 330, the wearable device 101 may obtain spatial information (e.g., a depth map) about at least a portion of the FoV of the user wearing the wearable device 101. Although not illustrated, a microphone for obtaining sound outputted from the external object may be disposed on the second surface 320 of the wearable device 101. The number of microphones may be one or more according to embodiments.

FIG. 4 illustrates an example of an operation for a wearable device to obtain a plurality of control data sets according to an embodiment of the disclosure. A wearable device 101 of FIG. 4 may be included in the wearable device 101 of FIG. 1.

Referring to FIG. 4, the wearable device 101 according to an embodiment may obtain a data set (e.g., the plurality of control data sets 135 of FIG. 1) for controlling a plurality of LEDs 160 to identify an eye of a user using a DVS camera 140. The wearable device 101 may output light toward the eye of the user based on brightness of each of the plurality of LEDs. The wearable device 101 may obtain frame images 410, 420, and 430 using the DVS camera 140 based on the light outputted toward the eye of the user. Referring to FIG. 4, although the frame images 410, 420, and 430 are illustrated as images corresponding to the eye, they may be obtained based on a format such as data of pixels indicating a change in the eye.

For example, the wearable device 101 may output light from each of the plurality of LEDs 160 by adjusting a brightness value corresponding to each of the plurality of LEDs 160 of FIG. 1. The wearable device 101 may output light from each of the plurality of LEDs 160 based on a designated period. The wearable device 101 may control at least one of the plurality of LEDs 160 to output light based on the designated period. The number of the plurality of LEDs 160 controlled by the wearable device 101 to output light may be different according to the designated period. The wearable device 101 may change the number of the plurality of LEDs 160 that output light and/or intensity of light corresponding to the light, according to the designated period, in order to identify the eye of the user.

For example, the wearable device 101 may guide a position of the eye using a user interface (not illustrated) for obtaining an image of the eye. The wearable device 101 may guide the position of the eye of the user based on the user interface for performing calibration, in order to control the plurality of LEDs 160 for identifying the eye. For example, while displaying the user interface on a display, the wearable device 101 may control the plurality of LEDs 160 to output light according to the designated period, and may obtain frame images indicating the eye using the DVS camera 140 based on the outputted light. The wearable device 101 may identify a state of the plurality of LEDs 160 corresponding to each of the frame images, according to whether the eye corresponding to each of the frame images has been identified. In order to identify the state of the plurality of LEDs 160 corresponding to each of the frame images, the wearable device 101 may synchronize a timing at which light is outputted from the plurality of LEDs 160 with a timing at which a frame image is obtained using the DVS camera 140. Based on identifying the timing at which the light is outputted from the plurality of LEDs 160 corresponding to the timing at which the frame image is obtained, the wearable device 101 may obtain the state of the plurality of LEDs 160 corresponding to the frame image. The state of the plurality of LEDs 160 may indicate an active state (or an inactive state) of the plurality of LEDs 160, and/or intensity of light emitted by each of the plurality of LEDs 160. For example, when identifying the eye using the frame image, the wearable device 101 may obtain a data set (e.g., the plurality of control data sets 135 of FIG. 1) indicating the state of the plurality of LEDs 160 corresponding to the frame image.

For example, the wearable device 101 may control a first LED 160-1 among the plurality of LEDs 160 to output light. The wearable device 101 may identify a change in an object (e.g., the eye of the user) based on light outputted using the DVS camera 140. The wearable device 101 may obtain a frame image 420 based on identifying the change in the object. The wearable device 101 may identify an eye 415-1 (or an iris) of the user using the frame image 420. The wearable device 101 may identify a shape 416 of the eye (or an iris pattern) based on identifying the eye 415-1 (or the iris) of the user. Since the shape 416 of the eye varies according to the user, the wearable device 101 may identify the user based on identifying the shape 416 of the eye. As an example, the wearable device 101 may authenticate the user after identifying the shape 416 of the eye, based on execution of the iris recognition software application 132 of FIG. 1.

For example, the wearable device 101 may obtain a control data set of the first LED 126-1 used to obtain the frame image 420, based on identifying the shape 416 of the eye. The control data set may include information indicating intensity of the light emitted from the first LED 126-1. The control data set may include brightness data of the frame image 420 corresponding to the intensity of the light outputted from the first LED 126-1. The brightness data may include brightness information on each of pixels of the frame image 420.

The wearable device 101 according to an embodiment may control a second LED 160-2 among the plurality of LEDs 160 to output light. The wearable device 101 may identify a change in an object (e.g., the eye of the user) based on the outputted light using the DVS camera 140. The wearable device 101 may obtain a frame image 430 based on identifying the change in the object. The wearable device 101 may identify an eye 415-2 of the user using the frame image 430. The wearable device 101 may identify a glint 440 caused by the light outputted from the second LED 160-2 in the frame image 430. For example, the glint 440 may be generated as the light outputted from the second LED 160-2 is reflected by the object (e.g., the eye of the user). The wearable device 101 may identify a shape 417 of the eye that is at least partially covered by the glint 440. Based on identifying the glint 440 that appears overlappingly on at least a portion of the eye 415-2 (or an iris), the wearable device 101 may refrain from storing a data set for controlling the second LED 160-2. Since the wearable device 101 may not accurately identify the shape 417 of the eye, it may refrain from storing the data set for controlling the second LED 160-2. However, it is not limited thereto.

For example, during a first time interval, the wearable device 101 may control the first LED 160-1 to obtain a frame image 410. As an example, the first LED 160-1 and/or the second LED 160-2 may be one or more. During a second time interval, the wearable device 101 may control the second LED 160-2 to obtain the frame image 430. The wearable device 101 may obtain a control data set indicating a state of the first LED 160-1 controlled during the first time interval based on identifying the eye (or the shape of the eye) using the frame image 420. The wearable device 101 may refrain from obtaining a control data set indicating a state of the second LED 160-2 controlled during the second time interval based on identifying the eye (or the shape of the eye) that is at least partially covered by the glint 440 using the frame image 430. For example, the wearable device 101 may obtain a control data set for accurately identifying the shape of the eye (or the iris) of the user. The wearable device 101 may obtain a control data set for at least one of the plurality of LEDs controlled to obtain the frame image, using a degree of preservation of the shape of the eye and/or a validity of the shape of the eye (e.g., a parameter indicating a degree to which the user may be identified).

The wearable device 101 according to an embodiment as described above may control the plurality of LEDs 160 to output light according to the position of the eye of the user. The wearable device 101 may obtain one or more frame images 420 and 430 using the DVS camera 140 based on the outputted light. The wearable device 101 may identify the frame image 420 in which the eye may be recognized among the one or more frame images 420 and 430. The wearable device 101 may obtain a data set indicating the state of the first LED 160-1 controlled to obtain the frame image 420. The wearable device 101 may obtain the plurality of control data sets 135 for controlling each of the plurality of LEDs 160 using a designated period, brightness, and/or an order to identify the position of the eye of the user, based on calibration.

FIG. 5 illustrates an example of a flowchart indicating an operation of a wearable device according to an embodiment of the disclosure. A wearable device of FIG. 5 may include the wearable device 101 of FIGS. 1, 2A, 2B, 3A, 3B, and 4. At least one of operations of FIG. 5 may be performed by the wearable device 101 of FIG. 1. At least one of the operations of FIG. 5 may be controlled by the processor 120 of FIG. 1. Each of the operations of FIG. 5 may be performed sequentially, but is not necessarily performed sequentially. For example, an order of each of the operations may be changed, and at least two operations may be performed in parallel.

Referring to FIG. 5, in operation 510, a processor according to an embodiment may obtain first image data from a DVS camera based on first light emitted from a plurality of LEDs using a first control data set among a plurality of control data sets for controlling the plurality of LEDs. As an example, the processor may output the first light by combining a portion of the plurality of LEDs using the first control data set during a first time interval. The plurality of control data sets may be obtained through a user interface for performing calibration on an eye of a user by the wearable device 101. The plurality of control data sets may include information indicating intensity of light outputted by each of the plurality of LEDs that may identify the eye of the user according to a position of the eye of the user. The processor may identify a change in the eye of the user by light emitted from the plurality of LEDs, using the DVS camera. The processor may obtain the first image data indicating the change in the eye based on identifying the change in the eye using the DVS camera. The first image data may include binary-based image data obtained in the time interval in which the first light was outputted using the first control data set.

Referring to FIG. 5, in operation 520, the processor according to an embodiment may obtain second image data from the DVS camera based on second light emitted from the plurality of LEDs using a second control data set. The operation 520 may refer to the operation 510. As an example, the processor may output the second light by combining another portion of the plurality of LEDs using the second control data set during a second time interval. However, it is not limited thereto. A portion of the plurality of LEDs controlled during the first time interval may overlap with another portion of the plurality of LEDs controlled during the second time interval.

Referring to FIG. 5, in operation 530, the processor according to an embodiment may convert the first image data and the second image data into an image using first brightness data corresponding to the first light and second brightness data corresponding to the second light. The processor may adjust (or change) an order of the plurality of control data sets used to obtain the first image data and the second image data, in order to encrypt information on the eye of the user. For example, based on adjusting (or changing) the order of the plurality of control data sets, the processor may control the plurality of LEDs using each of the changed plurality of control data sets. For example, the processor may obtain the first image data after obtaining the second image data. The processor may obtain the second image data based on the second control data set during the first time interval, and then obtain the first image data based on the first control data set during the second time interval.

For example, the processor may convert a first combination of the first image data and the first brightness data, and a second combination of the second image data and the second brightness data into an image. The image may include an object indicating the eye. For example, the processor may obtain information on the first light to identify the first brightness data corresponding to the first image data. The information on the first light may be included in the first control data set. The first combination may be obtained by calculating the first image data and the first brightness data based on a designated computation (e.g., multiplication). The second combination may be obtained by calculating the second image data and the second brightness data based on a designated computation (e.g., multiplication). The first combination and/or the second combination may be obtained based on a matrix format based on two dimensions. However, it is not limited thereto. For example, the processor may infer the first brightness data based on intensity of the first light outputted from each of the plurality of LEDs.

Referring to FIG. 5, in operation 540, the processor according to an embodiment may execute a function related to the eye based on identifying the eye of the user wearing the wearable device using the image. For example, the function related to the eye may include a function for authenticating the user using iris recognition, a function for tracking the eye (or a gaze), and/or a function for recognizing a face of the user.

Hereinafter, with reference to FIG. 6, an example of an operation in which a wearable device according to an embodiment obtains image data corresponding to each of the plurality of control data sets will be described later.

FIG. 6 illustrates an example of an operation in which a wearable device obtains image data according to an embodiment of the disclosure. A wearable device 101 of FIG. 6 may include the wearable device 101 of FIGS. 1, 2A, 2B, 3A, 3B, 4, and 5.

Referring to FIG. 6, a state 600 is illustrated in which the wearable device 101 according to an embodiment controls a plurality of LEDs 160 based on a plurality of control data sets 135 to obtain image data 620.

The wearable device 101 according to an embodiment may identify the plurality of control data sets 135 obtained using calibration. The wearable device 101 may control the plurality of LEDs 160 using the plurality of control data sets 135 based on identifying a designated condition.

For example, the designated condition may include execution of the gaze tracking software application 131 of FIG. 1. The designated condition may include execution of an iris recognition software application 132. The designated condition may include a case in which movement of an external object (e.g., an eyelid) related to the eye of the user is identified. The designated condition may include a case in which a signal for tracking a gaze of the user is lost. For example, the designated condition may include a case in which a designated time has elapsed after identifying the eye of the user using a DVS camera 140. For example, the designated condition may include a case in which the designated time has elapsed in a state in which a change in the eye of the user has not been identified after identifying the eye of the user using the DVS camera 140. As an example, the wearable device 101 may initiate performance of an operation for checking the eye using the plurality of control data sets 135 to check a position of the eye of the user, in a state in which a change in the eye of the user has not been identified after identifying the eye of the user. However, it is not limited thereto.

For example, the wearable device 101 may control the plurality of LEDs 160 based on a first control data set 135-1 among the plurality of control data sets 135. The plurality of control data sets 135 may include the first control data set 135-1 to an Nth control data set 135-N, according to an embodiment. The wearable device 101 may control the plurality of LEDs 160 using at least one of the plurality of control data sets 135. The wearable device 101 may select the number of control data sets to be used to obtain an image for identifying the eye using image data obtained through the DVS camera 140. However, it is not limited thereto. The wearable device 101 may output first light 605 from the plurality of LEDs 160 based on the first control data set 135-1. The wearable device 101 may identify at least a portion of the first light 605 reflected by an object through the DVS camera 140. The wearable device 101 may obtain a plurality of pixels 610 based on identifying at least a portion of the reflected first light 605. The plurality of pixels 610 may indicate an image formed on the DVS camera 140 by at least a portion of the reflected first light 605. A size of the plurality of pixels 610 may, for example, have a size corresponding to a field of view (FoV) of the DVS camera 140.

For example, the wearable device 101 may obtain first image data 620-1 based on identifying at least a portion of the first light 605 reflected by the object through the DVS camera 140. The wearable device 101 may obtain the first image data 620-1 based on intensity of the first light 605. For example, when the intensity of the first light is a first value (e.g., 1) and data on a first pixel 610-1 is a second value (e.g., 3), sensing data obtained from at least a portion of the first light reflected by the first pixel 610-1 may be a third value (e.g., 3). As an example, the wearable device 101 may identify a value equal to or greater than a threshold value (e.g., 2). The wearable device may temporarily refrain from obtaining a value equal to or less than the threshold value. When sensing data obtained from another portion of the first light reflected by the first pixel 610-1 is equal to or less than the threshold value (e.g., 2), the wearable device 101 may obtain data similar to the first image data 620-1. However, it is not limited thereto. The wearable device 101 may identify the first control data set 135-1 corresponding to the first image data 620-1. The wearable device 101 may identify the first control data set 135-1 used to obtain the first image data 620-1. The wearable device 101 may identify the intensity of the first light 605 outputted based on the first control data set 135-1. The wearable device 101 may identify brightness data by the first light reflected by the first light 605.

For example, the wearable device 101 may control the plurality of LEDs 160 using a second control data set 135-2. The number of the plurality of LEDs 160 controlled using the first control data set 135-1, and/or intensity of outputted light, and the number of the plurality of LEDs 160 controlled using the second control data set 135-2, and/or intensity of outputted light may be different. The wearable device 101 may control the plurality of LEDs 160 using the second control data set 135-2 to emit second light 606 toward an object (e.g., the eye of the user) 610. The wearable device 101 may identify at least a portion of the second light 606 reflected by the object through the DVS camera 140. The wearable device 101 may obtain second image data 620-2 based on identifying at least a portion of the second light 606. The wearable device 101 may identify intensity of the second light 606 outputted based on the second control data set 135-2. The wearable device 101 may identify brightness data corresponding to the intensity of the second light 606.

For example, when the intensity of the second light is a first value (e.g., 2) and data on pixels 610-1, 610-2, and 610-3 is a second value (e.g., 3) or a third value (e.g., 2), sensing data obtained from at least a portion of the second light reflected by the pixels 610-1, 610-2, and 610-3 may be a fourth value (e.g., 6 or 4). As an example, the wearable device 101 may identify a value equal to or greater than a threshold value (e.g., 4). The wearable device 101 may obtain the second image data 620-2 based on identifying a portion of the second light 606 reflected from each of the pixels 610-1, 610-2, and 610-3. However, it is not limited thereto.

The wearable device 101 according to an embodiment may obtain the image data 620 based on a changed order by changing an order of the plurality of control data sets 135 corresponding to the image data 620 in order to encrypt the image data. For example, the wearable device 101 may change the order of the plurality of control data sets 135 to protect an image (e.g., an image corresponding to the eye) to be obtained by decrypting using the image data 620. The wearable device 101 may randomly change the order of the plurality of control data sets 135. For example, the wearable device 101 may change the order of the plurality of control data sets 135 based on intensity of light corresponding to each of the plurality of control data sets 135. For example, the wearable device 101 may obtain the image data 620 by performing randomization of at least a portion of the plurality of control data sets 135. The number of the image data 620 may be equal to the number of control data sets used to emit light using the plurality of LEDs 160 among the plurality of control data sets 135.

For example, the wearable device 101 may identify brightness data matching an image (e.g., the image for identifying the eye) using the image data 620. The brightness data may correspond to each of the plurality of control data sets 135. The brightness data may correspond to intensity of light outputted from the plurality of LEDs 160 controlled by the plurality of control data sets 135. The wearable device 101 may obtain the image for identifying the eye using the image data 620 and the brightness data matching the image data. For example, the wearable device 101 may use the brightness data matching the image data 620 to analyze the image data 620 obtained over time. In order to use the brightness data matching the image data 620, the wearable device 101 may identify the order of the plurality of control data sets 135. As an example, since the brightness data matching the image data 620 may not be obtained in a case in which the order of the plurality of control data sets 135 is not identified, the wearable device 101 may not be able to analyze the image data 620.

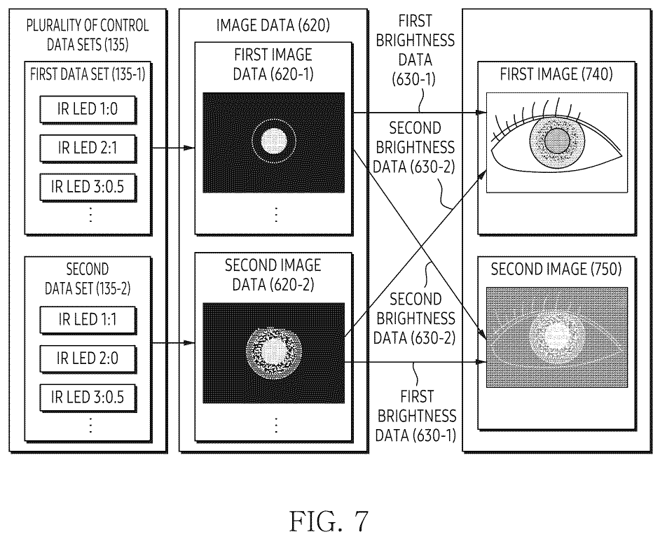

Hereinafter, with reference to FIG. 7, an example of an operation in which the wearable device 101 according to an embodiment obtains an image indicating the eye by combining brightness data and image data will be described later.

FIG. 7 illustrates an example of image data in which a wearable device is mapped to a plurality of control data sets according to an embodiment of the disclosure. A wearable device 101 of FIG. 7 may include the wearable device 101 of FIGS. 1, 2A, 2B, 3A, 3B, and 4 to 6.

Referring to FIG. 7, the wearable device 101 according to an embodiment may obtain image data 620 through a DVS camera 140 based on light outputted from a plurality of LEDs (e.g., the plurality of LEDs 160 of FIG. 1) using a plurality of control data sets 135. The wearable device 101 may identify a timing at which at least one of the plurality of control data sets 135 synchronized with a timing at which the image data 620 is obtained is used.

For example, the wearable device 101 may perform randomization of the plurality of control data sets 135. The wearable device 101 may control the plurality of LEDs 160 using a first control data set 135-1 among the plurality of control data sets 135. The first control data set 135-1 may include data configured to cause at least one of the plurality of LEDs 160 to output light based on designated brightness during a first time interval. For example, using the first control data set 135-1, the wearable device 101 may control a first LED among the plurality of LEDs 160 to be deactivated during the first time interval. Using the first control data set 135-1, the wearable device 101 may control a second LED to output light based on a first brightness value (e.g., 1) during the first time interval. Using the first control data set 135-1, the wearable device 101 may control a third LED to output light based on a second brightness value (e.g., 0.5) during the first time interval. However, it is not limited thereto.

For example, the wearable device 101 may control the plurality of LEDs 160 using the first control data set 135-1 to output first light toward an external object (e.g., an eye of a user). The wearable device 101 may obtain first image data 620-1 indicating at least a portion of the external object using the DVS camera 140. After controlling the plurality of LEDs 160 using the first control data set 135-1 during the first time interval, the wearable device 101 may control the plurality of LEDs 160 using a second control data set 135-2 during a second time interval. The wearable device 101 may emit second light through the plurality of LEDs 160 using the second control data set 135-2. The wearable device 101 may obtain second image data 620-2 based on identifying the second light reflected by the external object through the DVS camera 140.

For example, intensity of the first light outputted from the plurality of LEDs 160 controlled using the first control data set 135-1 and intensity of the second light outputted from the plurality of LEDs 160 controlled using the second control data set 135-2 may be different. The wearable device 101 may identify first brightness data 630-1 included in the first control data set 135-1 corresponding to the first image data 620-1. The wearable device 101 may identify second brightness data 630-2 included in the second control data set 135-2 corresponding to the second image data 620-2. The brightness data 630-1 and 630-2 may be referred to as a brightness parameter, a brightness value, and/or image brightness information.

For example, the wearable device 101 may obtain an image using a combination of image data and brightness data matching the image data, using Equation 1.

$${Img}_{i} = {Data}_{i} * {w}_{i} \qquad Equation 1$$

Referring to Equation 1, the Data_i may mean image data obtained by i-th light outputted from the plurality of LEDs 160. The Data_i may include binary-based data. The w_i may mean brightness data (e.g., a brightness value or a weight) corresponding to the i-th light. The w_i may mean image brightness corresponding to the image data. The i may correspond to i-th control data set based on an order of the plurality of control data sets 135. The Img_i may indicate a matrix based on three dimensions (e.g., W×H×1). The wearable device 101 may identify brightness data corresponding to at least one pixel in the Img_i to obtain an image using Equation 2 and Equation 3.

$$P\_ ( x , y ) = [ P\_ ( 1 , x , y ) , P\_ ( 2 , x , y ) , … , P\_ ( N , x , y ) ] \qquad Equation 2$$

Referring to Equation 2, the P_(N,x,y) may mean brightness data (or a brightness value) of a pixel located at (x,y) coordinates of Img_N. The P_(x,y) may mean a set of brightness data of a pixel located at (x,y) coordinates of the Img_i from the P_(1,x,y) to the P_(N,x,y). The wearable device 101 may select one value from the set of brightness data included in the P_(x,y) to obtain an image, using Equation 3.

$$P\_ ( r , x , y ) = max ( P\_ ( x , y ) ) \qquad Equation 3$$

Referring to Equation 3, the P_(r,x,y) may mean brightness data having the largest value within the set P_(x,y). In order to select one value from the set of brightness data, the wearable device 101 may select data having the smallest value or data having an average value within the set P_(x,y). The wearable device 101 may convert the image data 620 into a first image 740 using brightness data (e.g., the P_(r,x,y)) corresponding to one pixel (e.g., a pixel located at the (x,y) coordinates) in Img_i. The wearable device 101 may obtain the first image 740 by matching the image data 620 obtained over time with brightness data.

For example, based on obtaining the first image 740, the wearable device 101 may recognize feature information included in the first image 740. Based on recognizing the feature information, the wearable device 101 may obtain feature information indicating an eye of a user. Based on obtaining the feature information indicating the eye of the user, the wearable device 101 may identify a position of the eye and/or a shape of the eye (or an iris pattern).

For example, based on identifying the position of the eye, the wearable device 101 may execute a function (e.g., eye tracking) for identifying a gaze of the user corresponding to the position of the eye.

For example, based on identifying the shape of the eye, the wearable device 101 may execute a function for identifying the user. Based on the execution of the function, the wearable device 101 may authenticate the user.

The wearable device 101 according to an embodiment may obtain a second image 750 by matching brightness data obtained independently of the order of the plurality of control data sets 135 with the image data 620, independently of obtaining the first image 740 by matching brightness data obtained based on the order of the plurality of control data sets 135 with the image data 620. For example, the brightness data obtained independently of the order of the plurality of control data sets 135 may not be matched with the image data 620.

For example, the wearable device 101 may convert (or restore) the image data 620 into the second image 750 using a first combination of the first image data 620-1 and the second brightness data 630-2 (e.g., brightness data corresponding to the second control data set 135-2), and a second combination of the second image data 620-2 and the second brightness data 630-1. The wearable device 101 may obtain the second image 750 in which the feature information included in the first image 740 is lost. The wearable device 101 may fail to identify the eye of the user using the second image 750.

As described above, the wearable device 101 according to an embodiment may perform randomization of a portion of the plurality of control data sets 135 before capturing the eye of the user. The wearable device 101 may control the plurality of LEDs 160 using the randomized portion of the plurality of control data sets 135. The wearable device 101 may control the plurality of LEDs 160 to obtain the first image 740 by combining the image data 620 obtained through the DVS camera 140 with brightness data (e.g., the first brightness data 630-1 or the second brightness data 630-2) corresponding to the randomized portion of the plurality of control data sets 135. When the wearable device 101 matches the image data 620 with other brightness data distinct from the brightness data corresponding to the randomized portion, interpretation of the image data 620 may be impossible. The wearable device 101 may have an effect of encrypting the image data 620 based on performing randomization of a portion of the plurality of control data sets 135.

FIG. 8 illustrates an example of a flowchart indicating an operation of a wearable device according to an embodiment of the disclosure. A wearable device of FIG. 8 may include the wearable device 101 of FIGS. 1, 2A, 2B, 3A, 3B, and 4 to 7. At least one of operations of FIG. 8 may be performed by the wearable device 101 of FIG. 1. At least one of the operations of FIG. 8 may be controlled by the processor 120 of FIG. 1. Each of the operations of FIG. 8 may be performed sequentially, but is not necessarily performed sequentially. For example, an order of each of the operations may be changed, and at least two operations may be performed in parallel. At least one of the operations of FIG. 8 may be related to at least one of the operations of FIG. 5.

Referring to FIG. 8, in operation 810, a processor according to an embodiment may convert first image data and second image data into an image using first brightness data corresponding to first light and second brightness data corresponding to second light. The operation 810 may be related to the operation 540 of FIG. 5. For example, the processor may change an order of a plurality of control data sets for controlling a plurality of LEDs (e.g., the plurality of LEDs 160 of FIG. 1) by performing randomization of a plurality of control data sets 135. Based on the changed order, the processor may control the plurality of LEDs using the plurality of control data sets over time to emit light toward an external object (e.g., an eye of a user). The processor may obtain image data through a DVS camera based on the light emitted from the plurality of LEDs. The processor may identify a control data set used at a timing at which the image data is obtained. Based on identifying the control data set, the processor may identify brightness data included in the control data set. The brightness data may be matched to the image data. The processor may obtain an image by matching the brightness data with the image data.

Referring to FIG. 8, in operation 820, the processor according to an embodiment may check whether an eye has been identified using the image. The processor may identify feature information corresponding to the eye by extracting feature information of the image. The processor may identify whether feature information corresponding to an eye identified using calibration is included in the image.

Referring to FIG. 8, in operation 830, the processor according to an embodiment may execute a function related to the eye in a state in which the eye is identified using the image (the operation 820—YES). For example, based on identifying a position of the eye, the processor may track a gaze of the user. Based on identifying a shape of the eye (or an iris pattern), the processor may authenticate the user having the identified shape of the eye.

Referring to FIG. 8, in operation 840, in another state distinct from the state in which the eye is identified using the image (the operation 820—NO), the processor according to an embodiment may obtain third image data from the DVS camera based on third light to be emitted from at least one of the plurality of LEDs using a third control data set among the plurality of control data sets. For example, when the processor has identified a left eye using the image, the processor may refrain from using a control data set for controlling a plurality of LEDs corresponding to the left eye.

For example, when the processor has failed to identify a right eye using the image, it may identify a control data set for controlling a plurality of LEDs corresponding to the right eye. In order to identify the right eye, the processor may output the third light from at least one of the plurality of LEDs corresponding to the right eye using the control data set among the plurality of control data sets. The processor may temporarily cease emitting light using another LED corresponding to the left eye among the plurality of LEDs, and may output the third light from the at least one of the plurality of LEDs corresponding to the right eye. However, it is not limited thereto. The processor may obtain third image data from the DVS camera based on the third light. The processor may obtain an image for identifying the right eye by combining the third image data with brightness data corresponding to the third light. The processor may perform a function related to the eye based on identifying the left eye and the right eye.

The processor according to an embodiment may include the plurality of LEDs and/or the DVS camera disposed toward the outside of the wearable device. The processor may use the plurality of control data sets toward a body part (e.g., a hand) of the user to output light through the plurality of LEDs. The processor may receive the reflected light by using the DVS camera as the outputted light is reflected by the body part. The processor may obtain image data indicating the body part of the user by using the DVS camera. The processor may identify movement of the body part of the user by combining image data and brightness data corresponding to the light. However, it is not limited thereto.

FIG. 9 is a block diagram illustrating an electronic device 901 in a network environment 900 according to an embodiment of the disclosure. Referring to FIG. 9, the electronic device 901 in the network environment 900 may communicate with an electronic device 902 via a first network 998 (e.g., a short-range wireless communication network), or at least one of an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input module 950, a sound output module 955, a display module 960, an audio module 970, a sensor module 976, an interface 977, a connecting terminal 978, a haptic module 979, a camera module 980, a power management module 988, a battery 989, a communication module 990, a subscriber identification module (SIM) 996, or an antenna module 997. In some embodiments, at least one of the components (e.g., the connecting terminal 978) may be omitted from the electronic device 901, or one or more other components may be added in the electronic device 901. In some embodiments, some of the components (e.g., the sensor module 976, the camera module 980, or the antenna module 997) may be implemented as a single component (e.g., the display module 960).

The processor 920 may execute, for example, software (e.g., a program 940) to control at least one other component (e.g., a hardware or software component) of the electronic device 901 coupled with the processor 920, and may perform various data processing or computation. According to an embodiment, as at least part of the data processing or computation, the processor 920 may store a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), or an auxiliary processor 923 (e.g., a graphics processing unit (GPU), a neural processing unit (NPU), an image signal processor (ISP), a sensor hub processor, or a communication processor (CP)) that is operable independently from, or in conjunction with, the main processor 921. For example, when the electronic device 901 includes the main processor 921 and the auxiliary processor 923, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display module 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923. According to an embodiment, the auxiliary processor 923 (e.g., the neural processing unit) may include a hardware structure specified for artificial intelligence model processing. An artificial intelligence model may be generated by machine learning. Such learning may be performed, e.g., by the electronic device 901 where the artificial intelligence is performed or via a separate server (e.g., the server 908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input module 950 may receive a command or data to be used by another component (e.g., the processor 920) of the electronic device 901, from the outside (e.g., a user) of the electronic device 901. The input module 950 may include, for example, a microphone, a mouse, a keyboard, a key (e.g., a button), or a digital pen (e.g., a stylus pen).

The sound output module 955 may output sound signals to the outside of the electronic device 901. The sound output module 955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 960 may visually provide information to the outside (e.g., a user) of the electronic device 901. The display module 960 may include, for example, a display, a hologram device, or a projector and control circuitry to control a corresponding one of the display, hologram device, and projector. According to an embodiment, the display module 960 may include a touch sensor adapted to detect a touch, or a pressure sensor adapted to measure the intensity of force incurred by the touch.

The audio module 970 may convert a sound into an electrical signal and vice versa. According to an embodiment, the audio module 970 may obtain the sound via the input module 950, or output the sound via the sound output module 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to an embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The wireless communication module 992 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 992 may support a high-frequency band (e.g., the millimeter wave (mm Wave) band) to achieve, e.g., a high data transmission rate. The wireless communication module 992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 992 may support various requirements specified in the electronic device 901, an external electronic device (e.g., the electronic device 904), or a network system (e.g., the second network 999). According to an embodiment, the wireless communication module 992 may support a peak data rate (e.g., 20 Gbps or more) for implementing eMBB, loss coverage (e.g., 964 dB or less) for implementing mMTC, or U-plane latency (e.g., 0.5 ms or less for each of downlink (DL) and uplink (UL), or a round trip of 9 ms or less) for implementing URLLC.

The antenna module 997 may transmit or receive a signal or power to or from the outside (e.g., the external electronic device) of the electronic device 901. According to an embodiment, the antenna module 997 may include an antenna including a radiating element composed of a conductive material or a conductive pattern formed in or on a substrate (e.g., a printed circuit board (PCB)). According to an embodiment, the antenna module 997 may include a plurality of antennas (e.g., array antennas). In such a case, at least one antenna appropriate for a communication scheme used in the communication network, such as the first network 998 or the second network 999, may be selected, for example, by the communication module 990 (e.g., the wireless communication module 992) from the plurality of antennas. The signal or the power may then be transmitted or received between the communication module 990 and the external electronic device via the selected at least one antenna. According to an embodiment, another component (e.g., a radio frequency integrated circuit (RFIC)) other than the radiating element may be additionally formed as part of the antenna module 997.

According to various embodiments, the antenna module 997 may form a mm Wave antenna module. According to an embodiment, the mm Wave antenna module may include a printed circuit board, an RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 or 1304 may be a device of a same type as, or a different type, from the electronic device 901. According to an embodiment, all or some of operations to be executed at the electronic device 901 may be executed at one or more of the external electronic devices 902, 1304, or 1308. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, mobile edge computing (MEC), or client-server computing technology may be used, for example. The electronic device 901 may provide ultra low-latency services using, e.g., distributed computing or mobile edge computing. In another embodiment, the external electronic device 904 may include an internet-of-things (IoT) device. The server 908 may be an intelligent server using machine learning and/or a neural network. According to an embodiment, the external electronic device 904 or the server 908 may be included in the second network 999. The electronic device 901 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 940) including one or more instructions that are stored in a storage medium (e.g., internal memory 936 or external memory 938) that is readable by a machine (e.g., the electronic device 901). For example, a processor (e.g., the processor 920) of the machine (e.g., the electronic device 901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

An electronic device 101 of FIG. 9 may include the wearable device 101 of FIG. 1.

The wearable device according to an embodiment may obtain image data through a DVS camera based on light outputted from a plurality of LEDs. The wearable device may obtain an image for identifying an eye by combining a brightness value based on the light and the image data. A scheme for the wearable device to combine the brightness value and the image data may be required.

In a wearable device 101 according to an embodiment as described above, the wearable device may comprise a plurality of light emitting diodes (LEDs) 160, a dynamic vision sensor (DVS) camera 140, memory 130 comprising one or more storage mediums storing instructions, and at least one processor 120 comprising processing circuitry. The instructions, when executed by the at least one processor individually or collectively, may cause the wearable device to obtain, from the DVS camera, first image data 620-1 based on first light 605 emitted from the plurality of LEDs using a first control data set 135-1 among a plurality of control data sets 135 for controlling the plurality of LEDs. The instructions, when executed by the at least one processor individually or collectively, may cause the wearable device to obtain, from the DVS camera, second image data 620-2 based on second light 606 emitted from the plurality of LEDs using a second control data set 135-2 among the plurality of control data sets. The instructions, when executed by the at least one processor individually or collectively, may cause the wearable device to convert the first image data and the second image data into an image 740 using first brightness data 630-1 corresponding to the first light and second brightness data 630-2 corresponding to the second light. The instructions, when executed by the at least one processor individually or collectively, may cause the wearable device to, based on identifying an eye 415-1 or 415-2 of a user wearing the wearable device using the image, execute a function related to the eye.

For example, the instructions, when executed by the at least one processor individually or collectively, may cause the wearable device to, based on changing an order of the plurality of control data sets, control the plurality of LEDs using each of the changed plurality of control data sets.

For example, the instructions, when executed by the at least one processor individually or collectively, may cause the wearable device to convert a combination of the first brightness data and the first image data and another combination of the second brightness data and the second image data into the image.

For example, the instructions, when executed by the at least one processor individually or collectively, may cause the wearable device to execute the function for identifying a gaze of the user corresponding to a position of the eye based on identifying the position of the eye using the image.

For example, the instructions, when executed by the at least one processor individually or collectively, may cause the wearable device to execute the function for identifying the user based on identifying a shape 416 of the eye using the image.

For example, the plurality of control data sets may include information indicating intensity of light emitted by each of the plurality of LEDs to identify the eye of the user wearing the wearable device.

For example, the instructions, when executed by the at least one processor individually or collectively, may cause the wearable device to obtain another image 750 distinct from the image using the first image data matched to the second brightness data and the second image data matched to the first brightness data. The instructions, when executed by the at least one processor individually or collectively, may cause the wearable device to refrain from executing the function related to the eye using the other image.

For example, the instructions, when executed by the at least one processor individually or collectively, may cause the wearable device to obtain, from the DVS camera, third image data based on third light emitted from at least one of the plurality of LEDs using a third data set among the plurality of control data sets, in another state distinct from a state in which the eye is identified using the image.

In a method performed by a wearable device 101 according to an embodiment as described above, the method may comprise obtaining, from a DVS camera 140, first image data 620-1 based on first light 605 emitted from a plurality of LEDs 160 using a first control data set 135-1 among a plurality of control data sets 135 for controlling the plurality of LEDs. The method may comprise obtaining, from the DVS camera, second image data 620-2 based on second light 606 emitted from the plurality of LEDs using a second control data set 135-2 among the plurality of control data sets. The method may comprise converting the first image data and the second image data into an image 740 using first brightness data 630-1 corresponding to the first light and second brightness data 630-2 corresponding to the second light. The method may comprise, based on identifying an eye 415-1 or 415-2 of a user wearing the wearable device using the image, executing a function related to the eye.

For example, the method may comprise, based on changing an order of the plurality of control data sets, controlling the plurality of LEDs using each of the changed plurality of control data sets.

For example, the method may comprise converting a combination of the first brightness data and the first image data and another combination of the second brightness data and the second image data into the image.

For example, the method may comprise executing the function for identifying a gaze of the user corresponding to a position of the eye based on identifying the position of the eye using the image.

For example, the method may comprise executing the function for identifying the user based on identifying a shape 416 of the eye using the image.

For example, the plurality of control data sets may include information indicating intensity of light emitted by each of the plurality of LEDs to identify the eye of the user wearing the wearable device.

For example, the method may comprise obtaining another image 750 distinct from the image using the first image data matched to the second brightness data and the second image data matched to the first brightness data. The method may comprise refraining from executing the function related to the eye using the other image.

In a non-transitory computer-readable storage medium storing one or more programs according to an embodiment as described above, the one or more programs may be configured to include instructions that, when executed by a processor 120 of a wearable device 101, cause the wearable device to obtain, from a DVS camera 140, first image data 620-1 based on first light 605 emitted from a plurality of LEDs 160 using a first control data set 135-1 among a plurality of control data sets 135 for controlling the plurality of LEDs. The one or more programs may be configured to include instructions that, when executed by the processor of the wearable device, cause the wearable device to obtain, from the DVS camera, second image data 620-2 based on second light 606 emitted from the plurality of LEDs using a second control data set 135-2 among the plurality of control data sets. The one or more programs may be configured to include instructions that, when executed by the processor of the wearable device, cause the wearable device to convert the first image data and the second image data into an image 740 using first brightness data 630-1 corresponding to the first light and second brightness data 630-2 corresponding to the second light. The one or more programs may be configured to include instructions that, when executed by the processor of the wearable device, cause the wearable device to, based on identifying an eye 415-1 or 415-2 of a user wearing the wearable device using the image, execute a function related to the eye.

For example, the one or more programs may be configured to include instructions that, when executed by the processor of the wearable device, cause the wearable device to, based on changing an order of the plurality of control data sets, control the plurality of LEDs using each of the changed plurality of control data sets.

For example, the one or more programs may be configured to include instructions that, when executed by the processor of the wearable device, cause the wearable device to convert a combination of the first brightness data and the first image data and another combination of the second brightness data and the second image data into the image.

For example, the one or more programs may be configured to include instructions that, when executed by the processor of the wearable device, cause the wearable device to execute the function for identifying a gaze of the user corresponding to a position of the eye based on identifying the position of the eye using the image.

For example, the one or more programs may be configured to include instructions that, when executed by the processor of the wearable device, cause the wearable device to execute the function for identifying the user based on identifying a shape 416 of the eye using the image.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and digital versatile disc (DVD), magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable device comprising:
a plurality of light emitting diodes (LEDs);
a dynamic vision sensor (DVS) camera;
at least one processor comprising processing circuitry; and
memory comprising one or more storage mediums storing instructions,
wherein the instructions, when executed by the at least one processor individually or collectively, cause the wearable device to:
obtain, from the DVS camera, first image data based on first light emitted from the plurality of LEDs using a first control data set among a plurality of control data sets for controlling the plurality of LEDs,
obtain, from the DVS camera, second image data based on second light emitted from the plurality of LEDs using a second control data set among the plurality of control data sets,
using first brightness data corresponding to the first light and second brightness data corresponding to the second light, convert the first image data and the second image data into an image, and
based on identifying an eye of a user wearing the wearable device using the image, execute a function related to the eye.

2. The wearable device of claim 1, wherein the instructions, when executed by the at least one processor individually or collectively, cause the wearable device to:
based on changing an order of the plurality of control data sets, control the plurality of LEDs using each of the changed order of the plurality of control data sets.

3. The wearable device of claim 1, wherein the instructions, when executed by the at least one processor individually or collectively, cause the wearable device to:
convert a combination of the first brightness data and the first image data and another combination of the second brightness data and the second image data into the image.

4. The wearable device of claim 1, wherein the instructions, when executed by the at least one processor individually or collectively, cause the wearable device to:
execute the function for identifying a gaze of the user corresponding to a position of the eye based on identifying the position of the eye using the image.

5. The wearable device of claim 1, wherein the instructions, when executed by the at least one processor individually or collectively, cause the wearable device to:
execute the function for identifying the user based on identifying a shape of the eye using the image.

6. The wearable device of claim 1, wherein the plurality of control data sets include information indicating intensity of light emitted by each of the plurality of LEDs to identify the eye of the user wearing the wearable device.

7. The wearable device of claim 1, wherein the instructions, when executed by the at least one processor individually or collectively, cause the wearable device to:
obtain another image distinct from the image using the first image data matched to the second brightness data and the second image data matched to the first brightness data; and
refrain from executing the function related to the eye using the other image.

8. The wearable device of claim 1, wherein the instructions, when executed by the at least one processor individually or collectively, cause the wearable device to:
in another state distinct from a state in which the eye is identified using the image, obtain, from the DVS camera, third image data based on third light emitted from at least one of the plurality of LEDs using a third data set among the plurality of control data sets.

9. A method performed by a wearable device, the method comprising:
obtaining, by the wearable device, from a dynamic vision sensor (DVS) camera, first image data based on first light emitted from a plurality of light emitting diodes (LEDs) using a first control data set among a plurality of control data sets for controlling the plurality of LEDs;
obtaining, by the wearable device, from the DVS camera, second image data based on second light emitted from the plurality of LEDs using a second control data set among the plurality of control data sets;
using first brightness data corresponding to the first light and second brightness data corresponding to the second light, converting, by the wearable device, the first image data and the second image data into an image; and
based on identifying an eye of a user wearing the wearable device using the image, executing, by the wearable device, a function related to the eye.

10. The method of claim 9, further comprising:
based on changing an order of the plurality of control data sets, controlling the plurality of LEDs using each of the changed order of the plurality of control data sets.

11. The method of claim 9, further comprising:
converting a combination of the first brightness data and the first image data and another combination of the second brightness data and the second image data into the image.

12. The method of claim 9, further comprising:
executing the function for identifying a gaze of the user corresponding to a position of the eye based on identifying the position of the eye using the image.

13. The method of claim 9, further comprising:
executing the function for identifying the user based on identifying a shape of the eye using the image.

14. The method of claim 9, wherein the plurality of control data sets include information indicating intensity of light emitted by each of the plurality of LEDs to identify the eye of the user wearing the wearable device.

15. One or more non-transitory computer-readable storage media storing one or more computer programs including computer-executable instructions that, when executed by one or more processors of a wearable device individually or collectively, cause the wearable device to perform operations, the operations comprising:
obtaining, by the wearable device, from a dynamic vision sensor (DVS) camera, first image data based on first light emitted from a plurality of light emitting diodes (LEDs) using a first control data set among a plurality of control data sets for controlling the plurality of LEDs;
obtaining, by the wearable device, from the DVS camera, second image data based on second light emitted from the plurality of LEDs using a second control data set among the plurality of control data sets;
using first brightness data corresponding to the first light and second brightness data corresponding to the second light, converting, by the wearable device, the first image data and the second image data into an image; and
based on identifying an eye of a user wearing the wearable device using the image, executing, by the wearable device, a function related to the eye.

16. The one or more non-transitory computer-readable storage media of claim 15, the operations further comprising:
based on changing an order of the plurality of control data sets, controlling the plurality of LEDs using each of the changed order of the plurality of control data sets.

17. The one or more non-transitory computer-readable storage media of claim 15, the operations further comprising:
converting a combination of the first brightness data and the first image data and another combination of the second brightness data and the second image data into the image.

18. The one or more non-transitory computer-readable storage media of claim 15, the operations further comprising:
executing the function for identifying a gaze of the user corresponding to a position of the eye based on identifying the position of the eye using the image.

19. The one or more non-transitory computer-readable storage media of claim 15, the operations further comprising:
executing the function for identifying the user based on identifying a shape of the eye using the image.

20. The one or more non-transitory computer-readable storage media of claim 15, wherein the plurality of control data sets include information indicating intensity of light emitted by each of the plurality of LEDs to identify the eye of the user wearing the wearable device.
